(19) United States
(12) Patent Application Publication
(10) Pub. No.: US 2022/0410225 A1
(43) Pub. Date: Dec. 29, 2022

(54) WASHER ASSEMBLY FOR CLEARNING USED CHEMICAL JUGS

(71) Applicant: Paul Thomas Hitchens, Hessel, MI (US)

(72) Inventor: Paul Thomas Hitchens, Hessel, MI (US)

(21) Appl. No.: 17/846,176

(22) Filed: Jun. 22, 2022

Related U.S. Application Data
(60) Provisional application No. 63/213,825, filed on Jun. 23, 2021.

(51) Int. Cl. B08B 9/08; B08B 9/34

(52) U.S. Cl. CPC B08B 9/0813; B08B 9/0826; B08B 9/0852; B08B 9/34; B08B 2209/08

(57) ABSTRACT

A washer assembly for cleaning used chemical containers having a sealed chamber with a hingedly attached lid. A spray tube is supported in upright extending fashion upon a pan shaped basin of the sealed chamber. A fresh fluid inlet feeds pressurized fluid flow to the spray tube for spraying an inside of the chemical container placed over the tube, such that the fluid collects upon the basin. A drain is incorporated into the basin for removing contaminated fluid from the chamber.

### CROSS REFERENCE TO RELATED APPLICATIONS

The present application claims the priority of U.S. Ser. No. 63/213,825 filed Jun. 23, 2021.

### FIELD OF THE INVENTION

The present invention relates generally to container cleaning and washing techniques. More particularly, the present invention discloses a washer assembly for cleaning used chemical jugs or containers of any size, the assembly including a lid accessible and water-tight interior compartment for inserting and positioning the empty container in an inverted manner over an upright supported spray tube or rod. Each of pressurized fluid supply and drain connections are provided for cleaning the jug interior prior to removal and reuse or disposal of the jug or container.

### BACKGROUND OF THE INVENTION

The prior art is documented with numerous examples of jug cleaning and washing assemblies. One common practice is to insert a conventional hose into the jug interior and prior to dumping the contents into the spray tank.

An example of a chemical jug washer and disposal assembly is disclosed in US 2016/0303624 and related U.S. Pat. No. 10,603,699, to Hitchens, which teaches a combination cleaning and disposal assembly for safely cleaning and rendering unusable a jug containing a hazardous chemical residue. A body supports a receiving chamber for receiving the jug. A manifold is supported by the body and has a plurality of spikes arrayed toward the jug. A pressurized fluid source is communicated to the manifold such that, upon an inter-displacement occurs between the manifold and the container, the spikes are caused to pierce the container, the pressurized fluid being caused to issue from the spikes to clean an interior of the container. A drain is located underneath the jug receiving chamber which collects and segregates the fluid contaminated with the chemical residue for securing disposal concurrent with removing and disposing of the now-cleaned and punctured jug.

### SUMMARY OF THE PRESENT INVENTION

The present invention discloses a washer assembly for cleaning used chemical containers, such as prior to eventual disposal however also having the option to reuse the jug. The assembly has a sealed chamber with a hingedly attached lid. A spray tube is supported in upright extending fashion upon a pan shaped basin of the sealed chamber. A fresh fluid inlet feeds pressurized fluid flow to the spray tube for spraying an inside of the chemical container placed over the tube, such that the fluid collects upon the basin. A drain is incorporated into the basin for removing contaminated fluid from the chamber.

The fluid can also include water with or without a chemical additive. A rinse pump feeds the pressurized fluid flow through an inlet line connecting to the spray tube.

A drain pump is incorporated into the drain for withdrawing the fluid. The spray tube further includes a plurality of jet nozzles for redirecting the pressurized fluid evenly across an interior area of the container.

A fresh fluid reservoir connects to the fresh fluid inlet, with a contaminated fluid reservoir connecting to the drain. A common fluid reservoir connects to the drain via an intermediately located filtration system, the common reservoir having an outlet connecting to the fluid inlet.

A drain pump is incorporated into an inlet to the common reservoir, a rinse pump incorporated into the common reservoir outlet. An aperture platform is positioned above the drain for supporting an inverted top of the container positioned over the spray tube.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is plan cutaway view of a washer assembly according to a first variant of the present invention and illustrating an initial loading step for inserting a chemical jug to be washed over the upright spray tube;

FIG. 2 is a succeeding view to FIG. 1 in a use operation for spray rinsing the installed jug and showing the water proof lid sealed over the enclosure; and

FIG. 3 is a plan cutaway view of a washer assembly according to a second non-limiting variant of the present invention and illustrating a recirculating fluid reservoir with each of rinse and drain pumps, along with an integrated filtration system positioned on an inlet side of the reservoir for cleaning drained water prior to reuse.

### DETAILED DESCRIPTION OF THE PREFERRED EMBODIMENTS

With reference to the attached illustrations, the present invention discloses a washer assembly for cleaning used chemical jugs or containers of any size, the assembly including a lid accessible and water-tight interior compartment for inserting and positioning the empty container in an inverted manner over an upright supported spray tube or rod. Each of pressurized fluid supply and drain connections are provided for cleaning the jug interior prior to removal and reuse or disposal of the same.

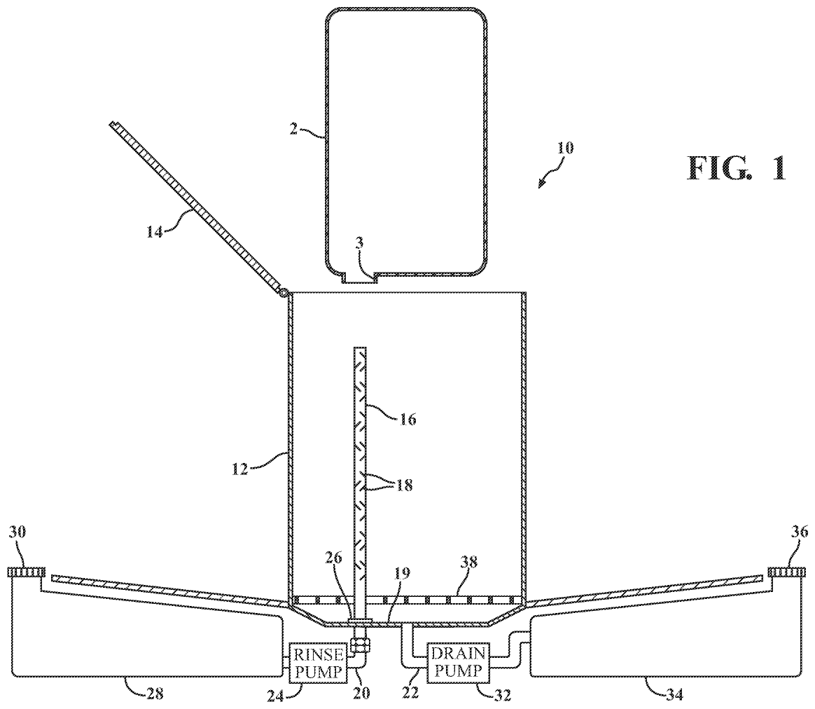

FIG. 1 is plan cutaway view of a washer assembly, generally at 10, according to a first variant of the present invention and illustrating an initial loading step for inserting a chemical jug, generally depicted at 2 with an upper-most neck communicating with a top opening (inverted at 3 in FIG. 1). Without limitation, the present invention contemplates the ability to clean any sized jug or container ranging from one gallon or greater to larger sized containers.

The washer assembly includes a body 12 defining a sealed inner chamber with a hingedly attached lid 14. The chamber can be constructed of any of a clear plexi-glass, other polycarbonate material, a metal or metal alloy including but not limited to aluminum. Upon rotating the lid 14 downwardly over the open top of the chamber, an interior enclosure of the chamber is sealed in order to be waterproof during subsequent operation.

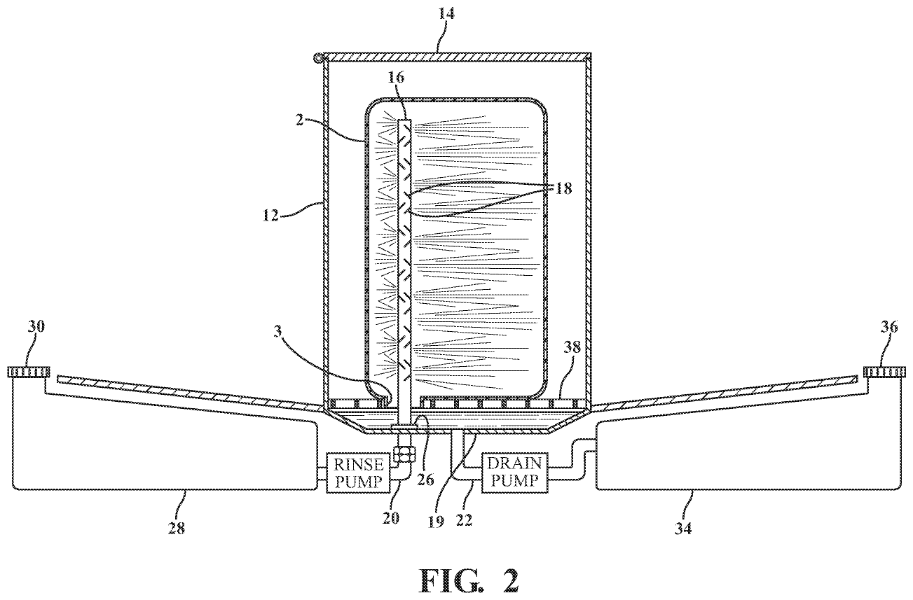

A spray tube 16 is supported in upright extending fashion upon a pan shaped basin 19 within the sealed chamber 12. The spray tube 16 further exhibits a plurality of jet nozzles (also defined as slits) 18 for redirecting the pressurized fluid evenly across an interior area of the container 2 (and as further shown in FIG. 2).

A fresh fluid inlet (or inlet line) 20 feeds pressurized fluid flow to the spray tube 16 for spraying an inside of the chemical container 2 placed over the tube 16 as referenced in either of FIGS. 1-2 and so that the fluid collects upon the pan shaped basin 19. A drain 22 (also outlet line) incorporated into the basin removes dirty or contaminated fluid from the chamber interior.

Without limitation, the fluid includes water with or without a chemical cleaning additive. In order to maintain pressurized fluid flow, a rinse pump 24 feeds the pressurized fluid flow through the inlet line 20 connecting to the upright affixed spray tube 16 (see further via a mounting nut 26 for upright affixing the tube within the enclosure.

A fresh fluid reservoir 28 is connected to the inlet line 20 and can include a removable cap 30 for ease of refilling and, if necessary, for mixing water with any desired chemical cleaning additive. Alternatively, the inlet 20 can connect directly to a separate pressurized fluid source such as a city water hooking, well water hookup or the like in which pressurized inlet fluid is provided without a separate inlet reservoir.

Upon washing the container and collecting the dirty/used fluid upon the pan shaped basin 19, the fluid is collected and drained via a drain pump 32. The dirty fluid can be connected to a dirty fluid reservoir 34, such also including a removable cap 36 for ease of emptying the reservoir. Alternatively, the dirty fluid reservoir can be substituted with a direct drain to any type of dirty water outlet. Also without limitation, the inlet 28 and outlet 34 reservoirs can either or both be incorporated into a housing containing the chamber or can be separately located.

An aperture platform 38 (not limited to a grill style grating, aperture plate or the like) is positioned above the drain for supporting an inverted top of the container 2 positioned over the spray tube 16. The sizing of the container 2 can again be varied up to any size, such as which will fit within the chamber interior 12.

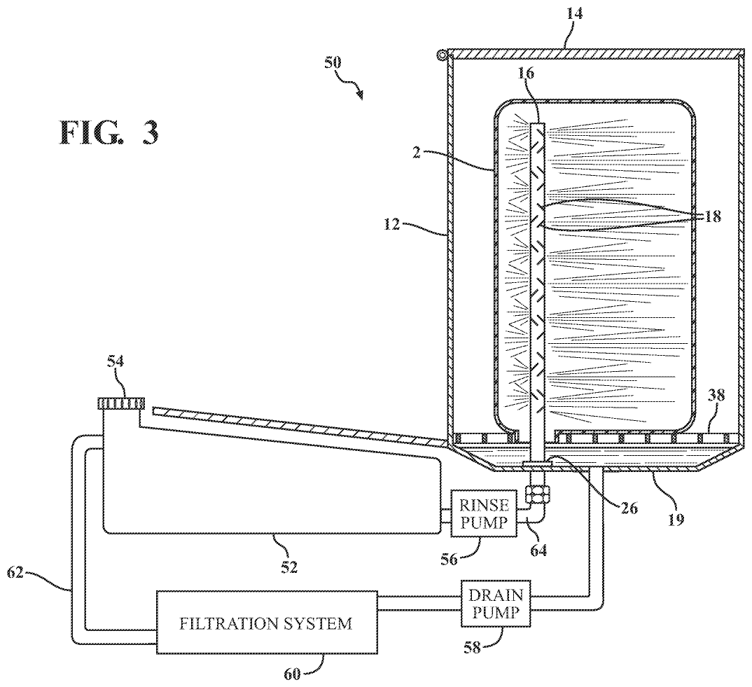

Referring to FIG. 3, a plan cutaway view is shown of a washer assembly according to a second non-limiting variant 50 of the present invention and illustrating a recirculating and common fluid reservoir 52 with a fill cap 54. Each of rinse 56 and drain 58 pumps, along with an integrated filtration system 60, are positioned respectively on an inlet (dirty) side such that a conduit 62 extending between the common fluid reservoir 52 and the filtration system 60 receives the dirty fluid pumped in by the drain pump 58 and prior to the reconditioned fluid from the common reservoir 52 being sent by the rinse pump 56 to the outlet (clean) side 64 for reuse through the spray tube 16 and nozzles 18. In this manner, a portable version of the washing assembly can utilize a fixed volume of fluid over a number of cleaning cycles, following which a removable cartridge (not shown) of the filtration system 60 can be replaced.

Having described my invention, other and additional preferred embodiments will become apparent to those skilled in the art to which it pertains, and without deviating from the scope of the appended claims. This can include envisioned variants in which multiple washing stations, each with a separate upright supported spray tube, is provided along with a common or individual segregated chambers in order to wash multiple chemical containers prior to either of disposal or reuse.

The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure, Having thus described embodiments of the present disclosure, a person of ordinary skill in the art will recognize that changes may be made in form and detail without departing from the scope of the present disclosure, Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A washer assembly for cleaning used chemical containers, comprising:
a sealed chamber with a hingedly attached lid;
a spray tube supported in upright extending fashion upon a pan shaped basin of said sealed chamber;
the used chemical container is adapted to being inverted within said chamber so that said spray tube is received through an opening in the top of the container;
a fresh fluid inlet feeding pressurized fluid flow to said spray tube for spraying an inside of the chemical container placed over said tube, said fluid collecting upon said basin located below the container; and
a drain incorporated into said basin for removing contaminated fluid from said chamber.

2. The washer assembly of claim 1, said fluid further comprising water with or without a chemical cleaning additive.

3. The washer assembly of claim 1, further comprising a rinse pump for feeding the pressurized fluid flow through an inlet line connecting to said spray tube.

4. The washer assembly of claim 3, further comprising a drain pump incorporated into said drain for withdrawing said fluid.

5. The washer assembly of claim 1, said spray tube further comprising a plurality of jet nozzles for redirecting the pressurized fluid evenly across an interior area of the container.

6. The washer assembly of claim 1, further comprising a fresh fluid reservoir connecting to the fresh fluid inlet.

7. The washer assembly of claim 1, further comprising a contaminated fluid reservoir connecting to the drain.

8. The washer assembly of claim 1, further comprising a common fluid reservoir connecting to said drain via an intermediately located filtration system, said common reservoir having an outlet connecting to said fluid inlet.

9. The washer assembly of claim 8, further comprising a drain pump incorporated into an inlet to said common reservoir, a rinse pump incorporated into said common reservoir outlet.

10. The washer assembly of claim 1, said pan shaped basin further comprising an aperture platform positioned above said drain for supporting an inverted top of the container positioned over said spray tube.
